(19) United States
(12) Patent Application Publication
(10) Pub. No.: US 2026/0371275 A1
(43) Pub. Date: Nov. 19, 2026

(54) INFORMATION TRANSCEIVING METHOD AND APPARATUS

(71) Applicant: 1FINITY Inc., Kawasaki-shi (JP)

(72) Inventors: Chao HAN, Beijing (CN); Meiyi JIA, Beijing (CN); Guorong LI, Beijing (CN)

(73) Assignee: 1FINITY Inc., Kawasaki-shi (JP)

(21) Appl. No.: 19/661,786

(22) Filed: Apr. 29, 2026

Related U.S. Application Data
(63) Continuation of application No. PCT/CN2023/129083, filed on Nov. 1, 2023.

(51) Int. Cl. H04W 56/00; H04L 1/1812; H04W 72/21

(52) U.S. Cl. CPC H04W 56/0045; H04L 1/1812; H04W 72/21

(57) ABSTRACT

An information transceiving method and apparatus. The method includes: receiving first configuration by a terminal equipment from a network device, the first configuration being at least used for indicating that a first TAG (timing advance group) is associated with a first resource, the first TAG including a first serving cell of the terminal equipment, and the first resource being a resource of the first serving cell of the terminal equipment.

### CROSS-REFERENCE TO RELATED APPLICATION

This application is a continuation application under 35 U.S.C. 111 (a) of International Patent Application PCT/CN2023/129083 filed on Nov. 1, 2023, and designated the U.S., the entire contents of which are incorporated herein by reference.

### TECHNICAL FIELD

This disclosure relates to the field of communication technologies.

### BACKGROUND

In current 3GPP protocols, features of multiple transmit/receive points (multi-TRP) has been introduced for the enhanced massive MIMO field. In a case of multi-TRP, a serving cell may schedule a terminal equipment (UE) via two TRPs, thereby providing better coverage, reliability, and potentially higher data transmission rates of physical channels, such as PDSCHs, PUSCHs, PDCCHs, and PUCCHs.

For the case of multi-TRP, there are single-DCI mode and multi-DCI mode. In the single-DCI mode, the same downlink control information (DCI) is used to schedule transmission of a UE at two TRPs, and in the multi-DCI mode, the UE is scheduled respectively by DCI independent of each other from different TRPs.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

In the discussion of the uplink and downlink MIMO evolution technology in Release 18, it was agreed to support two timing advances (TAs) in operations of a multi-DCI multi-TRP, and to configure two timing advance groups (TAGs) in the same serving cell, each being configured with a corresponding time alignment timer (TimeAlignmentTimer, TAT). That is, different TRP transmissions in the same serving cell may have different timing advance attributes, which belong to different TAGs.

In the current 3GPP specifications, as each serving cell only supports one TAG, when a TAT associated with this TAG expires, the UE needs to notify RRC to release PUCCHs and sounding reference signals (SRSs) configured by all serving cells related to this TAG, clear downlink allocated resources and configured uplink (UL) grants, and clear any PUSCH resources used for semi-persistent CSI report, etc. Configurations of all these resources are configured based on BWPs.

It was found by the inventor that as it is agreed in Release 18 that a serving cell supports two TAs in the case of multi-DCI and multi-TRP, that is, one serving cell may configure two TAGs, which correspond to different TATs, there may exist a case where in the same serving cell, one TAT expires while another TAT is still running, a TAG associated with the TAT that has not expired still has a reliable TA. Therefore, communication and data transmission may be continued to be performed between the serving cell and the UE by using a TRP corresponding to the TAG, and related services should not be affected. For the TAG with a TAT that has expired, related services will be affected, such as releasing and clearing related configuration resources, or buffering these resources for reacquiring synchronized service recovery. In either case, the UE needs to be able to distinguish a TAG to which relevant resources belong, and then maintain the resources based on the TAG, such as using, buffering, releasing, and clearing, etc. As the resources needing to be maintained are currently configured per BWP, it is difficult to distinguish them according to TAGs.

Supporting to configure two TAGs in a serving cell is enhancement in case of multi-DCI and multi-TRP introduced in Release 18. Currently, such resources as PUCCHs/SRSs/UL grants/DL assignment/PUSCHs for semi-persistent CSI report are configured based on BWPs, and there is no information associated with TAGs.

According to decisions in the discussions of Release 18, an association between TRPs and TAGs is not limited or bound, instead, an RRC message is used to specify a TAG with which each UL/Joint TCI-state is associated, or associate a TAG ID with a UL/Joint TCI state.

According to decisions in RAN1, a new parameter applyIndicatedTCIStateXX regarding an mTRP-UTCI (multi-TRP unified TCI) is introduced in configurations of relevant resources to notify the UE of a TCI state applied by the configured resources: {the first, the second, both, none}. The relevant resources are as follows:
BWP-DownlinkDedicated
ConfiguredGrantConfig
ControlResourceSet
CSI-Aperiodic TriggerStateList
PUCCH-Config
SRS-Config

However, in the above decisions in RAN1, an association between TCI states and TAGs is not indicated.

Another problem in the related art is that currently, within a configuration of each serving cell, a configuration of one TAG ID is only supported, and there is no description of how to indicate cases of supporting multiple TAGs in a cell in Release 18.

Therefore, currently, when a serving cell is configured with two TAGs, specifying an identity of the second TAG is not configured, and when a TAT to which one of the TAGs is related expires while a TAT to which the other TAG is related is still running, the UE is unable to capture use of resources which will be affected, that is, which resources are related to the TAG with the TAT that has expired. Therefore, resources in unreliable TA states cannot be separately released or buffered, while keeping resources in normal TA states proceeding with services. These resources are either fully reserved, resulting in resource waste, or completely cleared or released, causing effects on services to which resources with normal TAs correspond.

In order to solve one or more of the above problems, embodiments of this disclosure provide an information transceiving method and apparatus.

According to a first aspect of the embodiments of this disclosure, there is provided an information transceiving apparatus, provided in a terminal equipment, the apparatus including: a receiving unit configured to receive first configuration from a network device, the first configuration being at least used for indicating that a first TAG (timing advance group) is associated with a first resource, the first TAG including a first serving cell of the terminal equipment, and the first resource being a resource of the first serving cell of the terminal equipment.

According to a second aspect of the embodiments of this disclosure, there is provided an information transceiving apparatus, provided in a network device, the apparatus including: a transmitting unit configured to transmit first configuration to a terminal equipment, the first configuration being at least used to indicate that a first TAG (timing advance group) is associated with a first resource, the first TAG including a first serving cell of the terminal equipment, and the first resource being a resource of the first serving cell of the terminal equipment.

According to a third aspect of the embodiments of this disclosure, there is provided a communication system, including a terminal equipment and/or a network device, the terminal equipment including the apparatus as described in the first aspect of the embodiments of this disclosure, and the network device including the apparatus as described in the second aspect of the embodiments of this disclosure.

According to a fourth aspect of the embodiments of this disclosure, there is provided an information transceiving method, applicable to a terminal equipment, the method including: receiving first configuration by the terminal equipment from a network device, the first configuration being at least used for indicating that a first TAG (timing advance group) is associated with a first resource, the first TAG including a first serving cell of the terminal equipment, and the first resource being a resource of the first serving cell of the terminal equipment.

According to a fifth aspect of the embodiments of this disclosure, there is provided an information transceiving method, applicable to a network device, the method including: transmitting first configuration by the network device to a terminal equipment, the first configuration being at least used to indicate that a first TAG (timing advance group) is associated with a first resource, the first TAG including a first serving cell of the terminal equipment, and the first resource being a resource of the first serving cell of the terminal equipment.

According to a sixth aspect of the embodiments of this disclosure, there is provided a computer readable program, which, when executed in an information transceiving apparatus or a terminal equipment, will cause the information transceiving apparatus or the terminal equipment to carry out the information transceiving method as described in the embodiment of the fourth aspect of this disclosure.

According to a seventh aspect of the embodiments of this disclosure, there is provided a computer readable program, which, when executed in an information transceiving apparatus or a network device, will cause the information transceiving apparatus or the network device to carry out the information transceiving method as described in the embodiment of the fifth aspect of this disclosure.

According to an eighth aspect of the embodiments of this disclosure, there is provided a computer readable medium, including a computer readable program, which will cause an information transceiving apparatus or a terminal equipment to carry out the information transceiving method as described in the embodiment of the fourth aspect of this disclosure.

According to a ninth aspect of the embodiments of this disclosure, there is provided a computer readable medium, including a computer readable program, which will cause an information transceiving apparatus or a network device to carry out the information transceiving method as described in the embodiment of the fifth aspect of this disclosure.

An advantage of the embodiments of this disclosure exists in that the terminal equipment receives a configuration at least indicating the association between TAGs and the resources of the serving cell from the network device, so that the terminal equipment is able to maintain these resources according to the TAGs, which may solve the problem that relevant resources are unable to be determined and processed separately when TATs to which some TAGs within the serving cell are related expire. Thus, services on available resources may be kept unaffected without waste of resources.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiments.

The drawings are included to provide further understanding of this disclosure, which constitute a part of the specification and illustrate the preferred embodiments of this disclosure, and are used for setting forth the principles of this disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings:

FIG. 1 is schematic diagram of a communication system of an embodiment of this disclosure;

FIG. 2 is a schematic diagram of a scenario of multi-TRP of the embodiment of this disclosure;

FIG. 3 is a schematic diagram of an information transceiving method of an embodiment of this disclosure;

FIG. 4 is another schematic diagram of the information transceiving method of the embodiment of this disclosure;

FIG. 5 is an interaction graph of the information transceiving method of the embodiment of this disclosure;

FIG. 6 is a schematic diagram of an information transceiving apparatus of an embodiment of this disclosure;

FIG. 7 is anther schematic diagram of the information transceiving apparatus of the embodiment of this disclosure;

FIG. 8 is a block diagram of a systematic structure of a terminal equipment of an embodiment of this disclosure;

FIG. 9 is a block diagram of a systematic structure of a network device of an embodiment of this disclosure;

FIG. 10 is a schematic diagram of an information transceiving method of an embodiment of this disclosure;

FIG. 11 is another schematic diagram of the information transceiving method of the embodiment of this disclosure;

FIG. 12 is a further schematic diagram of the information transceiving method of the embodiment of this disclosure;

FIG. 13 is still another schematic diagram of the information transceiving method of the embodiment of this disclosure; and

FIG. 14 is a schematic diagram of a method for processing expiration of time alignment timer of an embodiment of this disclosure.

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), high-speed packet access (HSPA), and New Radio (NR), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and NEW Radio (NR) in the future, etc., and/or other communication protocols that are currently known or will be developed in the future.

In the embodiments of this disclosure, the term “network device” or “network node”, for example, refers to a device in a communication system that accesses a user equipment to the communication network and provides services for the user equipment. The network device or network node may include but not limited to the following devices: a node and/or donor in an IAB architecture, a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. For example, a 5G base station gNB may include a gNB CU and one or more gNB DUs, wherein the gNB DU is a logical node of the gNB having a part of functions of the gNB. And a term “cell” may refer to a base station and/or its coverage area, depending on a context of the term. One gNB-DU supports one or more cells, and one cell is supported by one gNB-DU only.

In the embodiments of this disclosure, the term “user equipment (UE)” refers to, for example, an equipment accessing to a communication network and receiving network services via a network device, may also be referred to as “terminal equipment (TE)”. The terminal equipment may be fixed or mobile, and may also be referred to as a mobile station (MS), a terminal, a subscriber station (SS), an access terminal (AT), such as a terminal equipment supported by an IAB-node or IAB-donor under an IAB architecture.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

In the embodiments of this disclosure, “when . . . ”, “in a case of . . . ”, “for a case where . . . ” and “if” all indicate being based on one or more conditions or states, and in addition, these expressions are interchangeable.

Scenarios of the embodiments of this disclosure shall be described below by way of examples; however, this disclosure is not limited thereto.

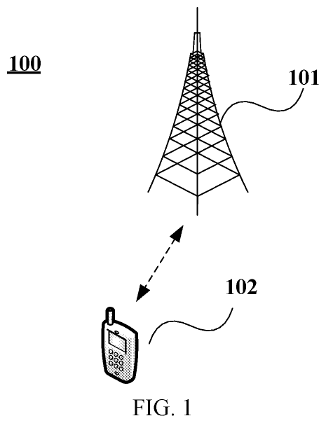

FIG. 1 is a schematic diagram of a communication system of an embodiment of this disclosure, in which a case where a terminal equipment and a network device are taken as examples is schematically shown. As shown in FIG. 1, a communication system 100 may include a network device 101 and a terminal equipment 102. For the sake of simplicity, an example having only one terminal equipment and one network device is schematically given in FIG. 1; however, the embodiment of this disclosure is not limited thereto.

In the embodiment of this disclosure, existing services or services that may be implemented in the future may be performed between the network device 101 and the terminal equipments 102, 103. For example, such services may include but not limited to an enhanced mobile broadband (eMBB), massive machine type communication (mMTC), and ultra-reliable and low-latency communication (URLLC), etc.

In the embodiments of this disclosure, high layer signaling may be, for example, radio resource control (RRC) signaling; for example, it is referred to an RRC message, which includes an MIB, system information, and a dedicated RRC message; or, it is referred to an as an RRC information element (RRC IE). high layer signaling may also be, for example, medium access control (MAC) signaling, or an MAC control element (MAC CE); however, this disclosure is not limited thereto.

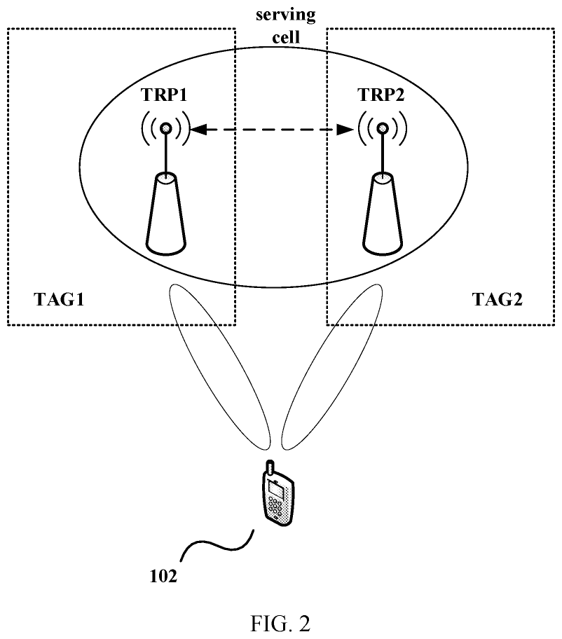

FIG. 2 is a schematic diagram of a scenario of multi-TRP of the embodiment of this disclosure. As shown in FIG. 2, a serving cell may schedule the terminal equipment 102 via two TRPs, TRP1 and TRP2. In addition, in a multi-DCI mode, the terminal equipment 102 is scheduled respectively by DCI independent of each other from different TRPs.

In addition, as shown in FIG. 2, two TAGs, TAG1 and TAG2, are configured in the same serving cell, each TAG being configured with a corresponding TAT. That is, different TRP transmissions of the same serving cell may have different timing advance attributes, belonging respectively to different TAGs, that is, transmission of TRP1 belongs to TAG1, and transmission of TRP2 belongs to TAG2.

Implementations of the embodiments of this disclosure shall be described below with reference to the accompanying drawings; however, these implementations are illustrative only, and are not intended to limit this disclosure.

### Embodiment of a First Aspect

The embodiment of this disclosure provides an information transceiving method, applicable to a terminal equipment, such as the terminal equipment 102 in FIG. 1 and FIG. 2.

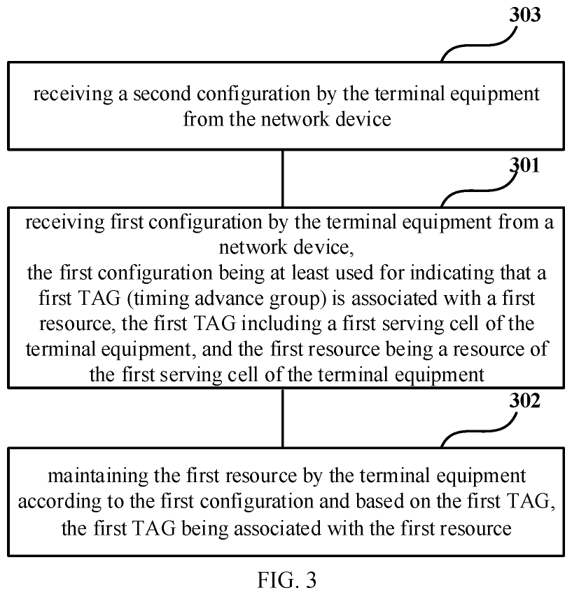

FIG. 3 is a schematic diagram of the information transceiving method of the embodiment of this disclosure. As shown in FIG. 3, the method includes:
301: receiving first configuration by the terminal equipment from a network device,
the first configuration being at least used for indicating that a first TAG (timing advance group) is associated with a first resource, the first TAG including a first serving cell of the terminal equipment, and the first resource being a resource of the first serving cell of the terminal equipment.

In some embodiments, two TAGs are configured in the same serving cell, a first TAG and a second TAG, such as TAG1 and TAG2 in FIG. 2. For example, the first TAG includes the first serving cell of the terminal equipment.

In some embodiments, the first configuration is at least used to indicate that the first TAG is associated with the first resource, the first resource being a resource of the first serving cell of the terminal equipment, that is, a resource configured for the first serving cell of the terminal equipment. In addition, the first serving cell refers to a serving cell of the terminal equipment.

For example, the first resource includes at least one of the following: a physical uplink control channel (PUCCH); a sounding reference signal (SRS); a downlink assignment; an uplink grant; and a physical uplink control channel (PUSCH) for semi-persistent CSI reporting.

Hence, when the TAT to which the first TAG is related expires while the TAT to which the second TAG is related is still running, the terminal equipment may buffer or suspend or release resources related to the first TAG the TAT that expires, without affecting communication transmission on resources related to the second TAG with the TAT that is still running.

In some embodiments, the first TCI state is associated with the first resource, and that the first TAG is associated with the first resource refers to that the first TCI state associated with the first resource is associated with the first TAG.

For example, the first TCI state related to the first resource includes at least one of the following: a first TCI state applicable to the first resource; a first TCI state applied to the first resource; or a first TCI state used for transmitting or receiving a signal on the first resource.

In some embodiments, the configuration information of the first TCI state includes an identity of the first TAG, and the first TCI state is associated with the first TAG. Thus, the first TAG is associated with the first resource.

For example, the identity of the first TAG is an ID of the first TAG.

In some embodiments, a configuration of the identity of the first TAG is a configuration or an optional configuration related to a number of TAGs included in the configuration information of the first serving cell.

In some embodiments, the TCI state includes an uplink TCI state and/or a downlink TCI state. For example, the TCI state is indicated by TCI-State.

For example, a field indicating the TAG ID is added to a TCI-State domain, and a field tag-Id is optionally configured, i.e. the field tag-Id is optional. When the serving cell configures two TAGs, the field tag-Id is used to indicate a TAG ID with which this TCI-State is associated. In addition, when the serving cell configures more than one TAG, this field is used to indicate a TAG to which this TCI-State is related; and when the serving cell configures only one TAG, this field may not be configured.

An example of TCI-State is as follows:

| | |
|---|---|
| TCI-State ::= | SEQUENCE { |
| tci-StateId | TCI-StateId, |

| | |
|---|---|
| tag-Id | TAG-Id, |

| OPTIONAL, | |
|---|---|
| qcl-Type1 | QCL-Info, |

| qcl-Type2 | QCL-Info |
|---|---|
| OPTIONAL, -- Need R | |
| ..., | |
| [[ | |
| additionalPCI-r17 | AdditionalPCIIndex-r17 |
| OPTIONAL, -- Need R | |
| pathlossReferenceRS-Id-r17 | PathlossReferenceRS-Id-r17 |
| OPTIONAL, -- Cond JointTCI1 | |
| ul-powerControl-r17 | Uplink-powerControlId-r17 |

OPTIONAL -- Cond JointTCI
]]
}

For example, a field used to indicate the TAG ID is added in a TCI-UL-State-r17 domain, tag-Id is optionally configured, i.e. the field tag-Id is optional.

When the serving cell configures two TAGs, the field tag-Id is used to indicate a TAG ID with which this TCI-State is associated. In addition, when the serving cell configures more than one TAG, this field is used to indicate a TAG to which this TCI-State is related; and when the serving cell configures only one TAG, this field may not be configured.

An example of TCI-UL-State-r17 is as follows:

| TCI-UL-State-r17 ::= | SEQUENCE { | |
|---|---|---|
| tci-UL-StateId-r17 | TCI-UL-StateId-r17, | |
| servingCellId-r17 | ServCellIndex | OPTIONAL, -- Need |

R

| | |
|---|---|
| tag-Id | TAG-Id, |

OPTIONAL,

| | | |
|---|---|---|
| bwp-Id-r17 | BWP-Id | OPTIONAL, -- Cond |

CSI-RSorSRS-Indicated
...
}

For example, for the field tag-Id, its definition may be: Timing Advance Group ID, as specified in TS 38.321 [3], indicates the TAG ID which this TCI-State associates to. This field is optional present when this cell belongs only one TAGs.

In some embodiments, the configuration information of the first TCI state includes an index of the first TAG in the configuration information of the first serving cell, and the first TCI state is associated with the first TAG.

In some embodiments, a configuration of the index of the first TAG is a configuration or related to a number of TAGs included in the configuration information of the first serving cell an optional configuration.

For example, a TAG indicating application is added in the TCI-State domain, and a field apply IndicatedTAG is optionally configured, i.e. the field apply IndicatedTAG is optional.

When the serving cell configures two TAGs, this field is used to indicate that this TCI State is associated with the first TAG or the second TAG of the serving cell. When the serving cell configures only one TAG, this field may not be configured.

An example of TCI-State is as follows:

| | |
|---|---|
| TCI-State ::= | SEQUENCE { |
| tci-StateId | TCI-StateId, |
| applyIndicatedTAG | {first, second} OPTIONAL, |
| qcl-Type1 | QCL-Info, |
| qcl-Type2 | QCL-Info |
| OPTIONAL, -- Need R | |
| ..., | |
| [[ | |
| additionalPCI-r17 | AdditionalPCIIndex-r17 |
| OPTIONAL, -- Need R | |
| pathlossReferenceRS-Id-r17 | PathlossReferenceRS-Id-r17 |
| OPTIONAL, -- Cond JointTCI1 | |
| ul-powerControl-r17 | Uplink-powerControlId-r17 |
| OPTIONAL -- Cond JointTCI | |
| ]] | |
| } | |

For another example, a TAG indicating application is added in the TCI-UL-State-r17 domain, and a field applyIndicatedTAG is optionally configured, i.e. the field applyIndicatedTAG is optional.

When the serving cell configures two TAGs, this field is used to indicate that this TCI State is associated with the first TAG or the second TAG of the serving cell. When the serving cell configures only one TAG, this field may not be configured.

An example of TCI-UL-State-r17 is as follows:

| TCI-UL-State-r17 ::= | SEQUENCE { |
|---|---|
| tci-UL-StateId-r17 | TCI-UL-StateId-r17, |
| servingCellId-r17 | ServCellIndex OPTIONAL, -- |
| Need R | |
| applyIndicatedTAG | {first, second} OPTIONAL, |
| bwp-Id-r17 | BWP-Id OPTIONAL, -- |
| Cond CSI-RSorSRS-Indicated | |
| ... | |
| } | |

For example, for the field applyIndicatedTAG, its definition may be: This field indicates which TAG of the serving cell to be applied for this TCI State, as specified in TS 38.321 [3], This field can be optional present when this cell belongs only one TAGs.

In some embodiments, the first TCI state associated with the first resource is a first TCI state applied to the first resource, the first TCI state applied to the first resource being indicated by a parameter related to applyIndicatedTCI-State included in the configuration information of the first resource. For example, the parameter related to applyIndicatedTCI-State is a parameter “applyIndicatedTCI-State-r18” or “applyIndicatedTCI-StateDCI-1-0-r18”.

In some embodiments, an indication of the parameter related to applyIndicatedTCI-State includes information of the first TAG, and the first TCI state applied to the first resource is associated with the first TAG. For example, the information of the first TAG includes index information of the first TAG in the configuration information of the first serving cell.

For example, for the parameter related to applyIndicatedTCI-State, a part in its definition used to indicate information of the first TAG may be: This field indicates, for PUCCH/PUSCH transmission(s) or PDCCH/PDSCH reception or CSI-RS resource (set) or SRS resource set, if UE applies the first, the second (or both or none of the) “indicated” UL/DL only TCI or joint TCI. The first indicated UL/DL only TCI or joint TCI is associated with the first TAG ID specified in the serving cell; And the second indicated UL/DL only TCI or joint TCI is associated with the second TAG ID specified in the serving cell.

That is, a first UL/DL only TCI or joint TCI is associated with the first TAG configured by the serving cell, and the second UL/DL only TCI or joint TCI is associated with the second TAG configured by the serving cell.

The terminal equipment establishes an association between the TAG ID and configuration resources of the serving cell according to an order of TAGs configured by the serving cell, and may maintain the configuration resources of the serving cell according to the TAGs.

In some embodiments, as shown in FIG. 3, the method further includes:
302: maintaining the first resource by the terminal equipment according to the first configuration and based on the first TAG, the first TAG being associated with the first resource.

For example, the terminal equipment buffers or suspends or releases the first resource according to the first TAG, wherein the first TAT (time alignment timer) expires.

For another example, the terminal equipment recovers the first resource according to the first TAG, wherein the first TAT is recovered from an expiration state to a running state, and the first TAT is associated with the first TAG.

In some embodiments, as shown in FIG. 3, the method further includes:
303: receiving a second configuration by the terminal equipment from the network device, the second configuration being used to configure the first serving cell of the terminal equipment, and the second configuration including information on the TAG to which the first serving cell belongs.

Operation 303 is optional.

Hence, by enhancing configurations of the TAGs in configurations of the serving cell, configuring two different TAGs in the same serving cell may be supported.

An existing configuration used to configure the serving cell of the terminal equipment includes a field tag-Id, which is defined as: Timing Advance Group ID, as specified in TS 38.321 [3], which this cell belongs to.

In some embodiments, the configuration of the information on the TAG to which the first serving cell belongs is multiple TAG identities and/or TAG extension identities, other TAG identities other than the first TAG identity in the multiple TAG identities being mandatory or optional configurations, and the extension identities being mandatory or optional configurations.

For example, an optional field tag-Id, such as tag-Id2 or tag-Id-Ext, is added to the configuration (second configuration) of the first serving cell of the terminal equipment, that is, field tag-Id2 or tag-Id-Ext is optional.

When the serving cell configures two TAGs, this field is used to indicate an ID of a second TAG. Additionally, when the serving cell configures only one TAG, this field may not be configured.

An example of a part of contents of the second configuration is as follows:

| | |
|---|---|
| ... | |
| crossCarrierSchedulingConfig | CrossCarrierSchedulingConfig |
| OPTIONAL, -- Need M | |
| tag-Id | TAG-Id, |
| tag-Id2 | TAG-Id, |
| OPTIONAL, | |
| dummy1 | ENUMERATED {enabled} |
| OPTIONAL, -- Need R | |
| ... | |

Another example of the part of contents of the second configuration is as follows:

| | |
|---|---|
| ... | |
| crossCarrierSchedulingConfig | CrossCarrierSchedulingConfig |
| OPTIONAL, -- Need M | |
| tag-Id | TAG-Id, |
| tag-Id-Ext | TAG-Id, |
| OPTIONAL, | |
| dummy1 | ENUMERATED {enabled} |
| OPTIONAL, -- Need R | |
| ... | |

For example, for the field tag-Id2 or tag-Id-Ext, its definition may be: Timing Advance Group ID, as specified in TS 38.321 [3], this field present when this cell belongs to more than one TAGs, indicates the second TAG ID which this cell belongs to.

In some embodiments, the configuration of the information of the TAG to which the first serving cell belongs is a TAG identity or TAG identity list of a SEQUENCE type.

In some embodiments, the configuration of the information of the TAG to which the first serving cell belongs is a TAG identity and a TAG extension identity or TAG identity list or TAG identity extension list of a mandatory or optional configuration of a SEQUENCE type.

In some embodiments, the TAG extension identity or TAG identity list or TAG identity extension list of the SEQUENCE type includes identities of other TAGs other than the first TAG to which the first serving cell belongs, and includes or does not include the identity of the first TAG to which the first serving cell belongs.

In one implementation, the configuration of tag-Id in the existing configuration is extended to a field tag-Id or tag-Id-List of a SEQUENCE type. When the serving cell configures more than one TAG, the SEQUENCE includes more than one TAG-Id, and the field is used to indicate the TAG identities configured by the serving cell.

A further example of the part of contents of the second configuration is as follows:

| | |
|---|---|
| ... | |
| crossCarrierSchedulingConfig | CrossCarrierSchedulingConfig |
| OPTIONAL, -- Need M | |
| tag-Id-List | SEQUENCE (SIZE(1.. |
| maxNrofTAGs)) OF TAG-Id, | |
| dummy1 | ENUMERATED {enabled}T |
| OPTIONAL, -- Need R | |
| ... | |

Still another example of the part of contents of the second configuration is as follows:

| | |
|---|---|
| ... | |
| crossCarrierSchedulingConfig | CrossCarrierSchedulingConfig |
| OPTIONAL, -- Need M | |
| tag-Id-List | SEQUENCE (SIZE(1.. |
| maxNrofTAGs)) OF TAG-Id, | |
| dummy1 | ENUMERATED {enabled}T |
| OPTIONAL, -- Need R | |
| ... | |

For example, for the field tag-Id or tag-Id-List, its definition may be: List of Timing Advance Group ID, as specified in TS 38.321 [3], which this cell belongs to. If the serving cell belong to more than one TAGs, more than one TAG ID will be included within the list.

In another implementation, a field tag-Id-Ext or tag-Id-List or tag-Id-ExtList of an optional configuration is added to the existing configuration, with a type of SEQUENCE. When the serving cell configures more than one TAG, this field is used to indicate the TAG identities configured by the serving cell.

Yet another example of the part of contents of the second configuration is as follows:

| ... | |
|---|---|
| crossCarrierSchedulingConfig | CrossCarrierSchedulingConfig |
| OPTIONAL, -- Need M | |
| tag-Id TAG-Id, | |
| tag-Id-Ext | SEQUENCE (SIZE(1.. |
| maxNrofTAGs)) OF TAG-Id, OPTIONAL, | |
| dummy1 | ENUMERATED {enabled} |
| OPTIONAL, -- Need R | |
| ... | |

Yet still another example of the part of contents of the second configuration is as follows:

| | |
|---|---|
| ... | |
| crossCarrierSchedulingConfig | CrossCarrierSchedulingConfig |
| OPTIONAL, -- Need M | |
| tag-Id | TAG-Id, |
| tag-Id-List | SEQUENCE (SIZE(1..maxNrofTAGs)) |
| OF TAG-Id, OPTIONAL, | |
| dummy1 | ENUMERATED {enabled}T |
| OPTIONAL, -- Need R | |

Yet further still another example of the part of contents of the second configuration is as follows:

| | |
|---|---|
| ... | |
| crossCarrierSchedulingConfig | CrossCarrierSchedulingConfig |
| OPTIONAL, -- Need M | |

tag-Id TAG-Id,

| | |
|---|---|
| tag-Id-ExtList | SEQUENCE (SIZE(1.. |
| maxNrofTAGs)) OF TAG-Id, OPTIONAL, | |
| dummy1 | ENUMERATED {enabled}T |
| OPTIONAL, -- Need R | |
| ... | |

For example, for the field tag-Id-Ext or tag-Id-List or tag-Id-ExtList, its definition may be: List of Timing Advance Group ID, as specified in TS 38.321 [3], this field present when this cell belongs to more than one TAGs, indicates the TAG IDs other than the first TAG ID which this cell belongs to.

Or, for the field tag-Id-Ext or tag-Id-List or tag-Id-ExtList, its definition may be: List of Timing Advance Group ID, as specified in TS 38.321 [3], this field present when this cell belongs to more than one TAGs, indicates the TAG IDs which this cell belongs to. If this field is present, the UE shall ignore field tag-Id.

It can be seen from the above embodiment that the terminal equipment receives a configuration at least indicating the association between TAGs and the resources of the serving cell from the network device, so that the terminal equipment is able to maintain these resources according to the TAGs, which may solve the problem that relevant resources are unable to be determined and processed separately when TATs to which some TAGs within the serving cell are related expire. Thus, services on available resources may be kept unaffected without waste of resources.

### Embodiment of a Second Aspect

The embodiment of this disclosure provides an information transceiving method, applicable to a network device. This method corresponds to the information transceiving method applicable to the terminal equipment described in the embodiment of the first aspect, and reference may be made to the disclosure contained in the embodiment of the first aspect for identical or corresponding contents.

This method is applicable to a network device, such as the network device 101 in FIG. 1.

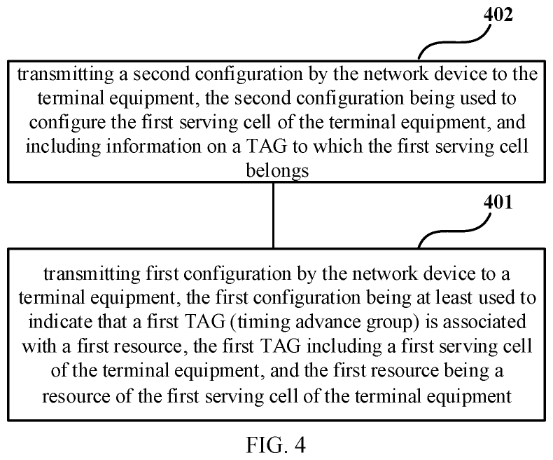

FIG. 4 is another schematic diagram of the information transceiving method of the embodiment of this disclosure. As shown in FIG. 4, the method includes:
401: transmitting first configuration by the network device to a terminal equipment, the first configuration being at least used to indicate that a first TAG (timing advance group) is associated with a first resource, the first TAG including a first serving cell of the terminal equipment, and the first resource being a resource of the first serving cell of the terminal equipment.

In some embodiments, as shown in FIG. 4, the method further includes:
402: transmitting a second configuration by the network device to the terminal equipment, the second configuration being used to configure the first serving cell of the terminal equipment, and including information on a TAG to which the first serving cell belongs.

In the embodiment of this disclosure, reference may be made to the disclosure contained in the embodiment of the first aspect for implementations of operations 401 and 402, which shall not be repeated herein any further.

It can be seen from the above embodiment that the network device transmits a configuration at least indicating the association between TAGs and the resources of the serving cell to the terminal equipment, so that the terminal equipment is able to maintain these resources according to the TAGs, which may solve the problem that relevant resources are unable to be determined and processed separately when TATs to which some TAGs within the serving cell are related expire. Thus, services on available resources may be kept unaffected without waste of resources.

### Embodiment of a Third Aspect

The embodiment of this disclosure provides an information transceiving method, applicable to a terminal equipment and a network device, such as the terminal equipment 102 and the network device 101 in FIG. 1 and FIG. 2. This method corresponds to the information transceiving methods described in the embodiment of the first aspect and the embodiment of the second aspect, with identical contents being not going to be repeated herein any further.

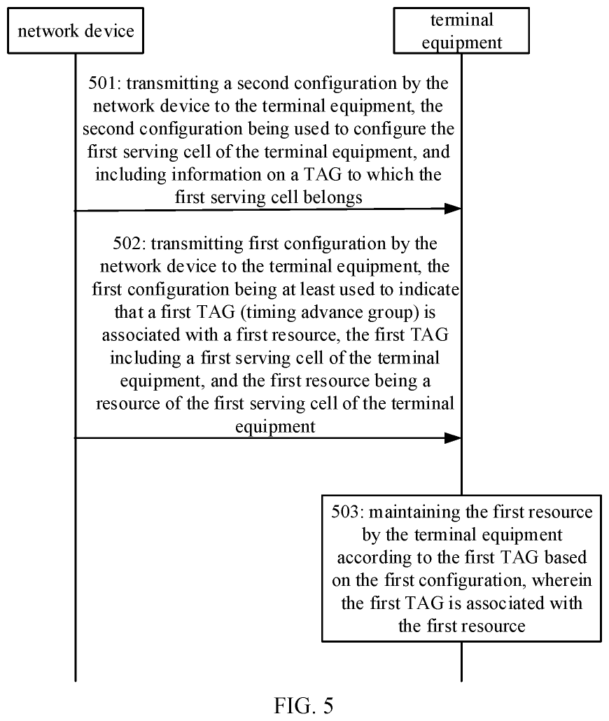

FIG. 5 is an interaction graph of the information transceiving method of the embodiment of this disclosure, applicable to a terminal equipment and a network device. As shown in FIG. 5, the method includes:
501: transmitting a second configuration by the network device to the terminal equipment, the second configuration being used to configure the first serving cell of the terminal equipment, and including information on a TAG to which the first serving cell belongs;
502: transmitting first configuration by the network device to the terminal equipment, the first configuration being at least used to indicate that a first TAG (timing advance group) is associated with a first resource, the first TAG including a first serving cell of the terminal equipment, and the first resource being a resource of the first serving cell of the terminal equipment; and
503: maintaining the first resource by the terminal equipment according to the first TAG based on the first configuration, wherein the first TAG is associated with the first resource.

In the embodiment of this disclosure, reference may be made to the disclosure contained in the embodiment of the first aspect for implementations of operations 501-503, which shall not be repeated herein any further.

It can be seen from the above embodiment that the terminal equipment receives a configuration at least indicating the association between TAGs and the resources of the serving cell from the network device, so that the terminal equipment is able to maintain these resources according to the TAGs, which may solve the problem that relevant resources are unable to be determined and processed separately when TATs to which some TAGs within the serving cell are related expire. Thus, services on available resources may be kept unaffected without waste of resources.

### Embodiment of a Fourth Aspect

The embodiment of this disclosure provides an information transceiving apparatus, provided in a terminal equipment. As a principle of the apparatus for solving problems is similar to that of the method in the embodiment of the first aspect, reference may be made to the implementation of the method described in embodiment of the first aspect for implementation of the apparatus, with identical or related contents being not going to be described herein any further.

FIG. 6 is a schematic diagram of the of the embodiment of this disclosure. As shown in FIG. 6, an apparatus 600 includes:
a receiving unit 601 configured to receive first configuration from a network device,
the first configuration being at least used for indicating that a first TAG (timing advance group) is associated with a first resource, the first TAG including a first serving cell of the terminal equipment, and the first resource being a resource of the first serving cell of the terminal equipment.

In some embodiments, the first TAG is associated with the first resource, wherein a first TCI state related to the first resource is associated with the first TAG, and the first TCI state related to the first resource includes at least one of the following:
a first TCI state applicable to the first resource;
a first TCI state applied to the first resource; or
a first TCI state used for transmitting or receiving a signal on the first resource.

In some embodiments, the configuration information of the first TCI state includes an identifier of the first TAG, and the first TCI state is associated with the first TAG.

In some embodiments, a configuration of the identifier of the first TAG is a configuration or an optional configuration related to a number of TAGs included in the configuration information of the first serving cell.

In some embodiments, the configuration information of the first TCI state includes an index of the first TAG in the configuration information of the first serving cell, and the first TCI state is associated with the first TAG.

In some embodiments, a configuration of the index of the first TAG is a configuration or an optional configuration related to a number of TAGs comprised in the configuration information of the first serving cell.

In some embodiments, the first TCI state related to the first resource is a first TCI state applied to the first resource;
the first TCI state applied to the first resource being indicated by a parameter related to applyIndicatedTCI-State included in the configuration information of the first resource.

In some embodiments, an indication of the parameter related to pplyIndicatedTCI-State includes information of the first TAG, and the first TCI state applied to the first resource is associated with the first TAG.

In some embodiments, the information of the first TAG includes index information of the first TAG in the configuration information of the first serving cell.

In some embodiments, the first resource includes at least one of the following:
a physical uplink control channel (PUCCH);
a sounding reference signal (SRS);
a downlink assignment;
an uplink grant; or
a physical uplink control channel (PUSCH) for semi-persistent CSI reporting.

In some embodiments, as shown in FIG. 6, the apparatus 600 further includes:
a processing unit 602 configured to maintain the first resource according to the first TAG based on the first configuration, wherein the first TAG is associated with the first resource.

In some embodiments, the processing unit 602 buffers or suspends or releases the first resource according to the first TAG, wherein a first TAT (time alignment timer) expires; and/or,
the processing unit recovers the first resource according to the first TAG, wherein the first TAT is recovered from an expiration state into a running state;
and the first TAT is associated with the first TAG.

In some embodiments, the receiving unit 601 is further configured to receive a second configuration from the network device,
the second configuration being used to configure the first serving cell of the terminal equipment, and including information on a TAG to which the first serving cell belongs.

In some embodiments, a configuration of the information on the TAG to which the first serving cell belongs is multiple TAG identifiers and/or TAG extension identifiers,
TAG identifiers other than a first TAG identifier in the multiple TAG identifiers are mandatory configurations or optional configurations,
and the extension identifiers are mandatory configurations or optional configurations.

In some embodiments, the configuration of the information on the TAG to which the first serving cell belongs is a TAG identifier of a SEQUENCE type or a TAG identifier list.

In some embodiments, the configuration of the information on the TAG to which the first serving cell belongs is a TAG identifier and a TAG extension identifier of a SEQUENCE type or a TAG identifier list or a TAG identifier extension list of a mandatory or optional configuration.

In some embodiments, the TAG extension identifier of a SEQUENCE type or the TAG identifier list or the TAG identifier extension list comprises identifiers of other TAGs other than a first TAG to which the first serving cell belongs, and includes or does not include a identifier of the first TAG to which the first serving cell belongs.

It can be seen from the above embodiment that the terminal equipment receives a configuration at least indicating the association between TAGs and the resources of the serving cell from the network device, so that the terminal equipment is able to maintain these resources according to the TAGs, which may solve the problem that relevant resources are unable to be determined and processed separately when TATs to which some TAGs within the serving cell are related expire. Thus, services on available resources may be kept unaffected without waste of resources.

### Embodiment of a Fifth Aspect

The embodiment of this disclosure provides an information transceiving apparatus, provided in a network device. As a principle of the apparatus for solving problems is similar to that of the method in the embodiment of the second aspect, reference may be made to the implementation of the method described in embodiment of the second aspect for implementation of the apparatus, with identical or related contents being not going to be described herein any further.

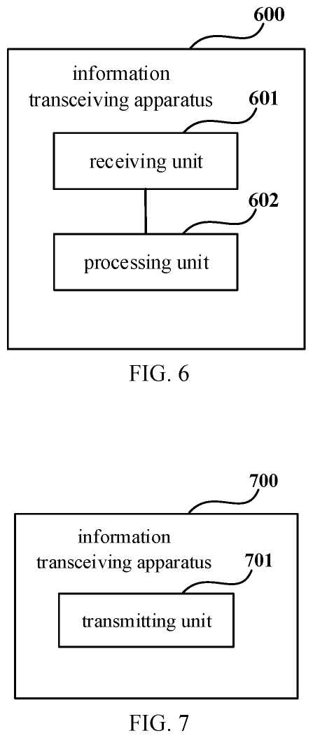

FIG. 7 is another schematic diagram of the information transceiving apparatus of the embodiment of this disclosure. As shown in FIG. 7, an apparatus 700 includes:
a transmitting unit 701 configured to transmit first configuration to a terminal equipment,
the first configuration being at least used to indicate that a first TAG (timing advance group) is associated with a first resource, the first TAG including a first serving cell of the terminal equipment, and the first resource being a resource of the first serving cell of the terminal equipment.

In some embodiments, the transmitting unit 701 is further configured to transmit a second configuration to the terminal equipment,
the second configuration being used to configure the first serving cell of the terminal equipment, and including information on a TAG to which the first serving cell belongs.

It can be seen from the above embodiment that the network device transmits a configuration at least indicating the association between TAGs and the resources of the serving cell to the terminal equipment, so that the terminal equipment is able to maintain these resources according to the TAGs, which may solve the problem that relevant resources are unable to be determined and processed separately when TATs to which some TAGs within the serving cell are related expire. Thus, services on available resources may be kept unaffected without waste of resources.

### Embodiment of a Sixth Aspect

The embodiment of this disclosure provides a terminal equipment, including the information transceiving apparatus described in the embodiment of the fourth aspect.

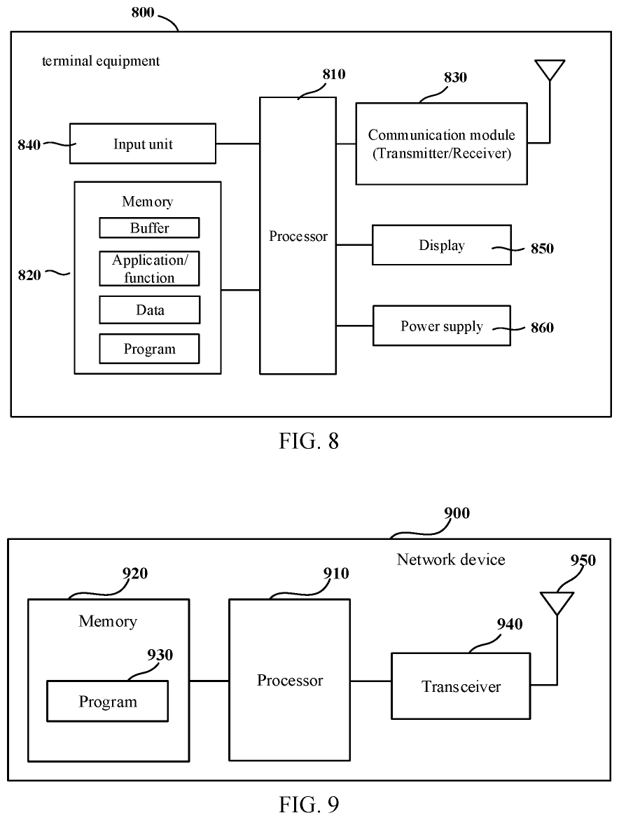

FIG. 8 is a block diagram of a systematic structure of the terminal equipment of the embodiment of this disclosure. As shown in FIG. 8, a terminal equipment 800 may include a processor 810 and a memory 820, the memory 820 being coupled to the processor 810. It should be noted that this figure is illustrative only, and other types of structures may also be used, so as to supplement or replace this structure and achieve a telecommunications function or other functions.

In one implementation, the functions of the information transceiving apparatus may be integrated into the processor 810.

The processor 801 may be configured to: receive first configuration from a network device, the first configuration being at least used for indicating that a first TAG (timing advance group) is associated with a first resource, the first TAG including a first serving cell of the terminal equipment, and the first resource being a resource of the first serving cell of the terminal equipment.

In another implementation, the information transceiving apparatus and the processor 810 may be configured separately; for example, the information transceiving apparatus may be configured as a chip connected to the processor 810, and the functions of the information transceiving apparatus are executed under control of the processor 810.

As shown in FIG. 8, the terminal equipment 800 may further include a communication module 830, an input unit 840, a display 850, and a power supply 860. It should be noted that the terminal equipment 800 does not necessarily include all the parts shown in FIG. 8, and the above components are not necessary. Furthermore, the terminal equipment 800 may include parts not shown in FIG. 8, and the related art may be referred to.

As shown in FIG. 8, the processor 810 is sometimes referred to as a controller or an operational control, which may include a microprocessor or other processor devices and/or logic devices. The processor 810 receives input and controls operations of components of the terminal equipment 800.

In some embodiments, the memory 820 may be, for example, one or more of a buffer memory, a flash memory, a hard drive, a mobile medium, a volatile memory, a nonvolatile memory, or other suitable devices, which may store various data, etc., and furthermore, store programs executing related information. And the processor 810 may execute programs stored in the memory 820, so as to realize information storage or processing, etc. Functions of other parts are similar to those of the related art, which shall not be described herein any further.

It can be seen from the above embodiment that the terminal equipment receives a configuration at least indicating the association between TAGs and the resources of the serving cell from the network device, so that the terminal equipment is able to maintain these resources according to the TAGs, which may solve the problem that relevant resources are unable to be determined and processed separately when TATs to which some TAGs within the serving cell are related expire. Thus, services on available resources may be kept unaffected without waste of resources.

### Embodiment of a Seventh Aspect

The embodiment of this disclosure provides a network device, including the information transceiving apparatus described in the embodiment of the fifth aspect.

FIG. 9 is a schematic diagram of a systematic structure of the network device of the embodiment of this disclosure. As shown in FIG. 9, a network device 900 may include a processor 910 and a memory 920, the memory 920 being coupled to the processor 910. Wherein, the memory 920 may store various data, and furthermore, it may store a program 930 for data processing, and execute the program 930 under control of the processor 910, so as to receive various information transmitted by a terminal equipment, and transmit various information to the terminal equipment.

In one implementation, the functions of the information transceiving apparatus may be integrated into the processor 910.

The processor 910 may be configured to: transmit first configuration to a terminal equipment, the first configuration being at least used to indicate that a first TAG (timing advance group) is associated with a first resource, the first TAG including a first serving cell of the terminal equipment, and the first resource being a resource of the first serving cell of the terminal equipment.

In another implementation, the information transceiving apparatus and the processor 910 may be configured separately; for example, the information transceiving apparatus may be configured as a chip connected to the processor 910, and the functions of the information transceiving apparatus are executed under control of the processor 910.

Furthermore, as shown in FIG. 9, the network device 900 may include a transceiver 940, and an antenna 950, etc. Wherein, functions of the above components are similar to those in the related art, and shall not be described herein any further. It should be noted that the network device 900 does not necessarily include all the parts shown in FIG. 9. Furthermore, the network device 900 may include parts not shown in FIG. 9, and the related art may be referred to.

It can be seen from the above embodiment that the network device transmits a configuration at least indicating the association between TAGs and the resources of the serving cell to the terminal equipment, so that the terminal equipment is able to maintain these resources according to the TAGs, which may solve the problem that relevant resources are unable to be determined and processed separately when TATs to which some TAGs within the serving cell are related expire. Thus, services on available resources may be kept unaffected without waste of resources.

### Embodiment of an Eighth Aspect

The embodiment of this disclosure provides a communication system, including the terminal equipment described in the embodiment of the sixth aspect and/or the network device described in the embodiment of the seventh aspect, and reference may be made to the embodiment of the sixth aspect and the embodiment of the seventh aspect for specific contents.

For example, reference may be made to FIG. 1 and FIG. 2 for a structure of the communication system. As shown in FIG. 1 and FIG. 2, the communication system 100 includes the network device 101 and the terminal equipment 102. The terminal equipment 102 may be identical to the terminal equipment described in the embodiment of the sixth aspect, and/or, the network device 101 may be identical to the network device described in the embodiment of the seventh aspect, with repeated parts being not going to be described herein any further.

### Embodiment of a Ninth Aspect

The embodiment of this disclosure provides an information transceiving method, applicable to a terminal equipment, such as the terminal equipment 102 in FIG. 1 and FIG. 2.

In some embodiments, for a case where multiple primary timing advance groups (PTAGs) are configured in an SpCell, by describing how to process applications of TA, a terminal equipment may be enabled to apply timing advance according to TAGs.

For example, as the SpCell may also support 2 TAGs and the TAGs are PTAGs, for TAC-related MAC CEs indicated to the terminal equipment, a PTAG to which information and definition are applied added is added.

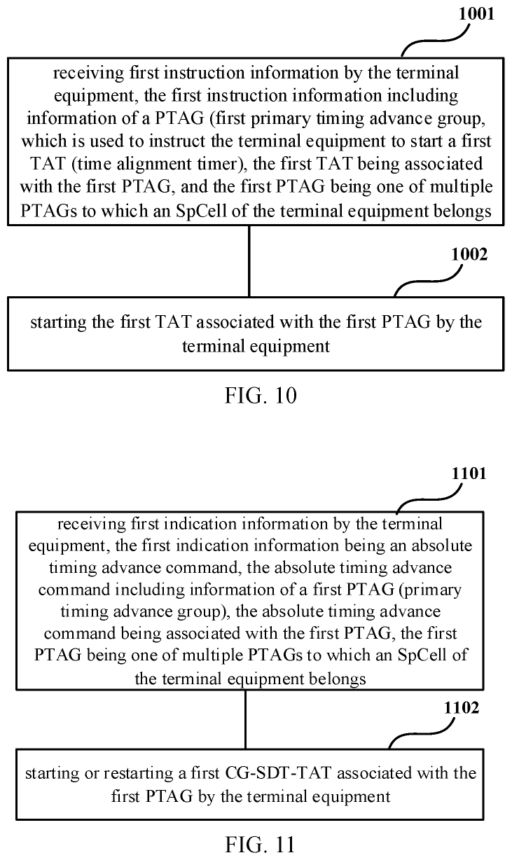

FIG. 10 is a schematic diagram of the information transceiving method of the embodiment of this disclosure. As shown in FIG. 10, the method includes:
1001: receiving first instruction information by the terminal equipment, the first instruction information including information of a PTAG (first primary timing advance group, which is used to instruct the terminal equipment to start a first TAT (time alignment timer), the first TAT being associated with the first PTAG, and the first PTAG being one of multiple PTAGs to which an SpCell of the terminal equipment belongs; and
1002: starting the first TAT associated with the first PTAG by the terminal equipment.

For example, the terminal equipment receives an instruction to start the TimeAlignmentTimer (TAT) of PTAG, and in a case where at least two PTAGs are configured in a relevant SpCell, the instruction needs to include a PTAG which is started by the TAT. An MAC entity of the terminal equipment initiates a TAT with which a specified PTAG is associated according to the instruction.

A specific example is as follows:

```
  1>when instruction from the upper layer has been received for starting the
    TimeAlignmentTimer associated with PTAG:
  2> start the TimeAlignmentTimer associated with PTAG indicated in the instruction from
the upper layer.
  Another specific example is as follows:
  1>when instruction from the upper layer has been received for starting the
    Time AlignmentTimer associated with PTAG for an SpCell configured with two TAGS:
    2>start the TimeAlignmentTimer associated with PTAG indicated in the instruction
    from the upper layer.
  1>when instruction from the upper layer has been received for starting the
    TimeAlignmentTimer associated with PTAG for an SpCell configured with only one
    TAGS:
  2> start the TimeAlignmentTimer associated with PTAG.
  A further specific example is as follows:
  1>when instruction from the upper layer has been received for starting the
    TimeAlignmentTimer associated with PTAG when the PTAG associated SpCell
    configured with two TAGS:
    2>start the TimeAlignmentTimer associated with PTAG indicated in the instruction
      from the upper layer.
  1>when instruction from the upper layer has been received for starting the
    Time AlignmentTimer associated with PTAG when the PTAG associated SpCell
    configured with only one TAGS:
  2> start the Time AlignmentTimer associated with PTAG.
```

FIG. 11 is another schematic diagram of the information transceiving method of the embodiment of this disclosure. As shown in FIG. 11, the method includes:
1101: receiving first indication information by the terminal equipment, the first indication information being an absolute timing advance command, the absolute timing advance command including information of a first PTAG (primary timing advance group), the absolute timing advance command being associated with the first PTAG, the first PTAG being one of multiple PTAGs to which an SpCell of the terminal equipment belongs; and
1102: starting or restarting a first CG-SDT-TAT associated with the first PTAG by the terminal equipment.

For example, the terminal equipment receives an instruction of the absolute timing advance command, and starts or restarts a TAT with which a specified PTAG is associated if a CG-SDT procedure is ongoing.

A specific example is as follows:

```
1>when an Absolute Timing Advance Command is received in response to a MSGA
    transmission including C-RNTI MAC CE for a SpCell configured with two TAGs as
    specified in clause 5.1.4a:
    2>apply the Timing Advance Command for the PTAG indicated in the Absolute Timing
        Advance Command MAC CE;
    2>if CG-SDT procedure is ongoing:
        3>start or restart the cg-SDT-TimeAlignmentTimer associated with this PTAG.
2> start or restart the timeAlignmentTimer associated with this PTAG.
Another specific example is as follows:
  1>when an Absolute Timing Advance Command is received in response to a MSGA
      transmission including C-RNTI MAC CE for a SpCell configured with two TAGs as
      specified in clause 5.1.4a:
      2>apply the Timing Advance Command for the PTAG indicated in the Absolute Timing
          Advance Command MAC CE;
      2>if CG-SDT procedure is ongoing:
          3>start or restart the cg-SDT-TimeAlignmentTimer associated with the PTAG
            indicated in the Absolute Timing Advance Command MAC CE.
2> start or restart the timeAlignmentTimer associated with this PTAG.
```

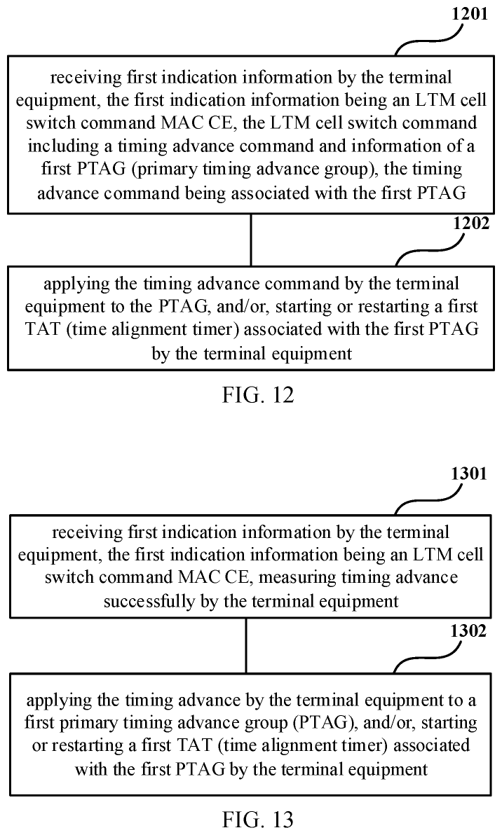

FIG. 12 is a further schematic diagram of the information transceiving method of the embodiment of this disclosure. As shown in FIG. 12, the method includes:
1201: receiving first indication information by the terminal equipment, the first indication information being an LTM cell switch command MAC CE, the LTM cell switch command including a timing advance command and information of a first PTAG (primary timing advance group), the timing advance command being associated with the first PTAG; and
1202: applying the timing advance command by the terminal equipment to the PTAG, and/or, starting or restarting a first TAT (time alignment timer) associated with the first PTAG by the terminal equipment.

For example, the terminal equipment receives the LTM cell switch command MAC CE, and applies the TA to a specified or related PTAG, and/or starts or restarts the TAT.

A specific example is as follows:

```
  1> when an LTM Cell Switch Command MAC CE including a Timing Advance Command
is received for the target SpCell configured with two TAGS:
    2> apply the Timing Advance Command for the PTAG indicated in the LTM Cell
Switch Command MAC CE;
    2> start or restart the timeAlignmentTimer associated with the PTAG indicated in the
LTM Cell Switch Command MAC CE;
```

FIG. 13 is still another schematic diagram of the information transceiving method of the embodiment of this disclosure. As shown in FIG. 13, the method includes:
1301: receiving first indication information by the terminal equipment, the first indication information being an LTM cell switch command MAC CE, measuring timing advance successfully by the terminal equipment; and
1302: applying the timing advance by the terminal equipment to a first primary timing advance group (PTAG), and/or, starting or restarting a first TAT (time alignment timer) associated with the first PTAG by the terminal equipment.

A specific example is as follows:

```
  1>when an LIM Cell Switch Command MAC is received and UE has
    successfully measured the Timing Advance as in clause 5.18.xy
    for the target SpCell configured with two TAGS:
    2>apply the measured Timing Advance for the PTAG associated
      with the measured Timing;
        2> start or restart the timeAlignmentTimer associated with
the associated with the measured Timing.
```

It can be seen from the above embodiment that for a case where multiple primary timing advance groups (PTAGs) are configured under an SpCell, by describing how to process applications of TA, the terminal equipment may be enabled to apply timing advance according to TAGs.

### Embodiment of a Tenth Aspect

The embodiment of this disclosure provides a method for processing expiration of time alignment timer, applicable to a terminal equipment, such as the terminal equipment 102 in FIG. 1 and FIG. 2.

In some embodiments, for a case where two TAGs, i.e. two PTAGs, are configured in an SpCell, if an SCell configures only one TAG and the TAG is identical to one of the PTAGs configured in the SpCell, which is not currently discussed in the specifications, and there is a need to supplement this situation.

A first SpCell of the terminal equipment belongs to at least two primary timing advance groups (PTAGs), a first SCell of the terminal equipment belongs only to a second one of the at least two PTAGs, and the first SCell and the first SpCell are included in a first cell group (CG) of the terminal equipment,
wherein the first SpCell is an SpCell of the terminal equipment, the first SCell is an SCell of the terminal equipment, and the first cell group is a cell group of the terminal equipment.

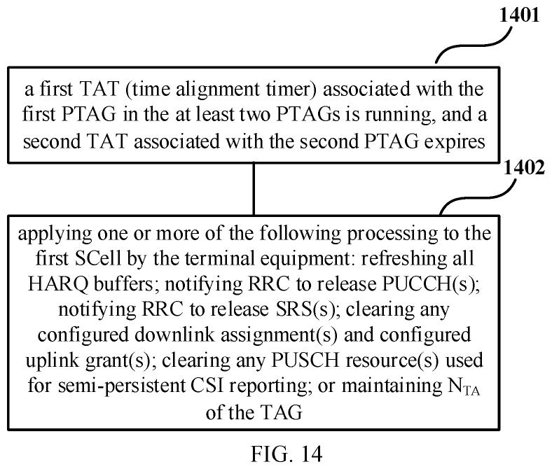

FIG. 14 is a schematic diagram of a method for processing expiration of time alignment timer of an embodiment of this disclosure. As shown in FIG. 14, the method includes:
1401: a first TAT (time alignment timer) associated with the first PTAG in the at least two PTAGs is running, and a second TAT associated with the second PTAG expires; and
1402: applying one or more of the following processing to the first SCell by the terminal equipment: refreshing all HARQ buffers; notifying RRC to release PUCCH(s); notifying RRC to release SRS(s); clearing any configured downlink assignment(s) and configured uplink grant(s); clearing any PUSCH resource(s) used for semi-persistent CSI reporting; or maintaining N_{TA} of the TAG.

A specific example is as follows:

```
  1> when a timeAlignmentTimer expires:
      2> if the time AlignmentTimer is associated with a PTAG, then for all Serving Cells
        configured with this TAG and only one TAG configured while a second PTAG of
        the associated SpCell for which the timeAlignmentTimer is running:
    3>flush all HARQ buffers;
    3>notify RRC to release PUCCH, if configured;
    3>notify RRC to release SRS, if configured;
    3>clear any configured downlink assignments and configured uplink grants;
    3>clear any PUSCH resource for semi-persistent CSI reporting;
3> maintain N_{TA} (defined in TS 38.211 [8]) of this TAG.
```

Another specific example is as follows:

```
  1> when a timeAlignmentTimer expires:
    2> if the timeAlignmentTimer is associated with a PTAG while TAT
      for the other PTAG of SpCell is running, then for all SCell
      belonging to this TAG and configured with only TAG:
    3>flush all HARQ buffers;
    3>notify RRC to release PUCCH, if configured;
    3>notify RRC to release SRS, if configured;
    3>clear any configured downlink assignments and configured
    uplink grants;
    3>clear any PUSCH resource for semi-persistent CSI reporting;
3> maintain N_{TA} (defined in TS 38.211 [8]) of this TAG.
```

It can be seen from the above embodiment that for a case where two TAGs, i.e. two PTAGs, are configured in an SpCell, if an SCell configures only one TAG and the TAG is identical to one of the PTAGs in the SpCell, by describing a process of processing a case where a TAT expires and another TAT is running, the terminal equipment is enabled to properly process in such a case.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in FIG. 6 may either correspond to software modules of procedures of a computer program, or correspond to hardware modules. Such software modules may respectively correspond to the steps shown in FIG. 3. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in FIG. 6 may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in FIG. 6 may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

According to the implementations disclosed in the embodiments of this disclosure, following supplements are further disclosed.

1. An information transceiving method, comprising:
receiving first indication information by a terminal equipment, the first indication information including first PTAG (primary timing advance group) information, which is used to instruct the terminal equipment to start a first TAT (time alignment timer), the first TAT being associated with the first PTAG, and the first PTAG being one of multiple PTAGs to which an SpCell of the terminal equipment belongs; and
starting the first TAT associated with the first PTAG by the terminal equipment.

2. An information transceiving method, comprising:
receiving first indication information by a terminal equipment, the first indication information being an absolute timing advance command, the absolute timing advance command including information of a first PTAG (primary timing advance group), the absolute timing advance command being associated with the first PTAG, the first PTAG being one of multiple PTAGs to which an SpCell of the terminal equipment belongs; and
starting or restarting a first CG-SDT-TAT associated with the first PTAG by the terminal equipment.

3. An information transceiving method, comprising:
receiving first indication information by a terminal equipment, the first indication information being an LTM Cell switch command MAC CE, the LTM cell switch command including a timing advance command and first PTAG (primary timing advance group) information, and the timing advance command being associated with the first PTAG;
applying timing advance command by the terminal equipment to the PTAG; and/or,
starting or restarting a first TAT (time alignment timer) associated with the first PTAG by the terminal equipment.

4. An information transceiving method, comprising:
receiving first indication information by a terminal equipment, the first indication information being an LTM cell switch command MAC CE, and successfully measuring timing advance by the terminal equipment;
applying the timing advance by the terminal equipment to a first primary timing advance group (PTAG) associated with the timing advance, and/or,
starting or restarting a first TAT (time alignment timer) associated with the first PTAG by the terminal equipment.

5. A method for processing expiration of a time alignment timer, wherein a first SpCell of a terminal equipment belongs to at least two PTAGs (primary timing advance groups), the first SCell of the terminal equipment belongs only to a second PTAG in the at least two PTAGs, and the first SCell and the first SpCell are included in a first CG (cell group) of the terminal equipment,
the method comprising:
a first TAT (time alignment timer) associated with the first PTAG in the at least two PTAGs is running, and the second TAT associated with the second PTAG expires;
the terminal equipment applies one or more pieces of the following processing to the first SCell:
flushing all HARQ buffer(s);
notifying RRC to release PUCCH(s);
notifying RRC to release SRS(s);
clearing any configured downlink assignment(s) and configured uplink grant(s);
clearing any PUSCH resources used for semi-persistent CSI reporting; and
maintaining N_{TA} of the TAG.

1. An information transceiving apparatus, provided in a terminal equipment, the apparatus comprising:
a receiver configured to receive first configuration from a network device, the first configuration being at least used for indicating that a first TAG (timing advance group) is associated with a first resource, the first TAG being a TAG of two TAGs configured for a first serving cell of the terminal equipment, and the first resource being a resource of the first serving cell of the terminal equipment, a first TCI state related to the first resource is associated with the first TAG; and
a processor configured to handle time alignment timer expiration, wherein,
a first SCell (Secondary Cell) of the terminal equipment belongs only to a TAG, and the first SCell is configured with only the TAG, the TAG is one of two PTAGs (Primary Timing Advance Groups) configured for a first SpCell (Special Cell), the other PTAG of the first SpCell is running, the first SpCell is a SpCell belong to a same cell group of the first SCell,
and wherein the processor is further configured to, responsive to a determination that a timeAlignmentTimer associated with the TAG has expired, cause the terminal equipment to apply one or more pieces of the following processing for the first SCell:
flushing all HARQ (Hybrid Automatic Repeat Request) buffer(s);
notifying RRC (Radio Resource Control) to release PUCCH (physical uplink control channel) (s);
notifying RRC to release SRS (Sounding Reference Signal) (s);
clearing any configured downlink assignment(s) and configured uplink grant(s);
clearing any PUSCH (physical uplink shared channel) resource(s) used for semi-persistent CSI (Channel State Information) reporting; or
maintaining N_{TA} of the TAG.

2. The apparatus according to claim 1, wherein,
the first TCI state comprises:
a first TCI state used for transmitting or receiving a signal on the first resource.

3. The apparatus according to claim 2, wherein,
configuration information of the first TCI state comprises an identifier of the first TAG, and the first TCI state is associated with the first TAG.

4. The apparatus according to claim 3, wherein,
a configuration of the identifier of the first TAG is an optional configuration related to a number of TAGs comprised in configuration information of the first serving cell.

5. The apparatus according to claim 2, wherein,
configuration information of the first TCI state comprises an index of the first TAG in configuration information of the first serving cell, and the first TCI state is associated with the first TAG.

6. The apparatus according to claim 5, wherein,
a configuration of the index of the first TAG is an optional configuration related to a number of TAGs comprised in the configuration information of the first serving cell.

7. The apparatus according to claim 1, wherein,
the first resource comprises at least one of the following:
a PUCCH;
a downlink assignment;
an uplink grant; or
a PUSCH for semi-persistent CSI reporting.

8. The apparatus according to claim 1, wherein
the processor is further configured to maintain the first resource according to the first TAG based on the first configuration, the first TAG is associated with the first resource.

9. The apparatus according to claim 8, wherein,
the processor is further configured to control to buffer or suspend or release the first resource according to the first TAG, wherein a first TAT (time alignment timer) expires
and the first TAT is associated with the first TAG.

10. The apparatus according to claim 1, wherein,
the receiver is further configured to receive a second configuration from the network device,
the second configuration being used to configure the first serving cell of the terminal equipment, and comprising information on a TAG to which the first serving cell belongs.

11. The apparatus according to claim 10, wherein,
a configuration of the information on the TAG to which the first serving cell belongs is multiple TAG identifiers,
TAG identifiers other than a first TAG identifier in the multiple TAG identifiers are optional configurations.

12. The apparatus according to claim 1, wherein,
the receiver is further configured to receive a first instruction from an upper layer by the terminal equipment, the first instruction comprising first PTAG information, which is used to instruct the terminal equipment to start a first TAT (time alignment timer), the first TAT being associated with the first PTAG; and
when the first instruction from the upper layer is received, the terminal equipment starts the first TAT associated with an indicated first PTAG.

13. The apparatus according to claim 1, wherein,
the receiver is further configured to receive an LTM (L1/L2 Triggered Mobility) Cell Switch Command MAC CE (Medium Access Control Control Element) by the terminal equipment, the LTM Cell Switch Command MAC CE comprising a timing advance command and first PTAG (primary timing advance group) information;
when the LTM Cell Switch Command MAC CE is received, the terminal equipment applies the timing advance command for a first PTAG indicated by the LTM Cell Switch Command MAC CE; and starts or restarts a first TAT (time alignment timer) associated with the first PTAG indicated by the LTM Cell Switch Command MAC CE.

14. The apparatus according to claim 1, wherein,
the receiver is further configured to receive an LTM (L1/L2 Triggered Mobility) Cell Switch Command MAC CE (Medium Access Control Control Element) by the terminal equipment;
when the LTM Cell Switch Command MAC CE is received, and the terminal equipment has successfully measured timing advance, the terminal equipment applies the timing advance for a PTAG (first primary timing advance group) associated with the timing advance; and starts or restarts a first TAT (time alignment timer) associated with the first PTAG.

15. An information transceiving apparatus, provided in a network device, the apparatus comprising:
a transmitter configured to transmit first configuration to a terminal equipment,
the first configuration being at least used to indicate that a first TAG (timing advance group) is associated with a first resource,
the first TAG being a TAG of two TAGs configured for a first serving cell of the terminal equipment,
the first resource being a resource of the first serving cell of the terminal equipment, and a first TCI state related to the first resource is associated with the first TAG.

16. The apparatus according to claim 15, wherein,
the transmitter is further configured to transmit a second configuration to the terminal equipment,
the second configuration being used to configure the first serving cell of the terminal equipment, and comprising information on a TAG to which the first serving cell belongs.

17. A communication system, comprising:
a network device configured to transmit first configuration to a terminal equipment, the first configuration being at least used to indicate that a first TAG (timing advance group) is associated with a first resource, the first TAG being a TAG of two TAGs configured for a first serving cell of the terminal equipment, the first resource being a resource of the first serving cell of the terminal equipment, and a first TCI state related to the first resource is associated with the first TAG; and
a terminal equipment configured to:
receive first configuration from a network device, the first configuration being at least used for indicating that a first TAG (timing advance group) is associated with a first resource, the first TAG being a TAG of two TAGs configured for a first serving cell of the terminal equipment, and the first resource being a resource of the first serving cell of the terminal equipment, a first TCI state related to the first resource is associated with the first TAG; and
handle time alignment timer expiration, wherein,
a first SCell (Secondary Cell) of the terminal equipment belongs only to a TAG, and the first SCell is configured with only the TAG, the TAG is one of two PTAGs (Primary Timing Advance Groups) configured for a first SpCell (Special Cell), the other PTAG of the first SpCell is running, the first SpCell is a SpCell belong to a same cell group of the first SCell,
and wherein the processor is further configured to, responsive to a determination that a timeAlignmentTimer associated with the TAG has expired, cause the terminal equipment to apply one or more pieces of the following processing for the first SCell:
flushing all HARQ (Hybrid Automatic Repeat Request) buffer(s);
notifying RRC (Radio Resource Control) to release PUCCH (physical uplink control channel) s;
notifying RRC to release SRS (Sounding Reference Signal) (s);
clearing any configured downlink assignment(s) and configured uplink grant(s);
clearing any PUSCH (physical uplink shared channel) resource(s) used for semi-persistent CSI (Channel State Information) reporting; or
maintaining N_{TA} of the TAG.
